(19) United States
(12) Patent Application Publication
(10) Pub. No.: US 2020/0192468 A1
(43) Pub. Date: Jun. 18, 2020

(54) DISPLAY SYSTEM AND METHOD FOR AN AIRCRAFT

(71) Applicant: Airbus Operations SAS, Toulouse (FR)

(72) Inventors: Javier MANJON SANCHEZ, TOULOUSE (FR); Cedric DESCHEEMAEKER, TOULOUSE (FR); Francis BLONDEL, TOULOUSE (FR)

(21) Appl. No.: 16/705,498

(22) Filed: Dec. 6, 2019

(30) Foreign Application Priority Data
Dec. 12, 2018 (FR) 1872772

(51) Int. Cl. G06F 3/01; G09G 5/10; G09G 5/37; B64D 45/00

(52) U.S. Cl. CPC G06F 3/012; G09G 5/10; G09G 5/37; G09G 2320/08; G09G 2380/12; G09G 2354/00; G09G 2320/0261; B64D 45/00

(57) ABSTRACT

An aircraft cockpit display system comprises a display device configured to be secured to a user's head, a sensor for sensing the position, orientation and/or acceleration of the user's head and a display computer controlling the display on the display device of at least one first consistently displayed symbol and of at least one second non-consistently displayed symbol. The display computer determines an angular velocity value of the user's head based on information provided by the sensor and controls the display on the display device in a first display mode when the angular velocity value is less than or equal to a predetermined angular velocity threshold and in a second display mode if not. In the second display mode, the visibility of the second piloting assistance symbol to the pilot is less than the visibility of the second piloting assistance symbol in the first display mode.

### CROSS-REFERENCES TO RELATED APPLICATIONS

This application claims the benefit of the French patent application No. 1872772 filed on Dec. 12, 2018, the entire disclosures of which are incorporated herein by way of reference.

### FIELD OF THE INVENTION

The invention relates to the display of piloting assistance information in an aircraft cockpit.

### BACKGROUND OF THE INVENTION

Modern aircraft, in particular transport planes, have a system for displaying piloting assistance information in their cockpit. A system of this kind, for example a CDS (control and display system), controls the display of information on screens, called head-down screens, in the cockpit: in order to view this information, the user, generally a pilot or copilot of the aircraft, has to lower his head in order to look at the screens. He is therefore not able to see the surroundings of the aircraft through a windscreen of the cockpit at the same time. In order to allow the user to see this information while at the same time monitoring the surroundings of the aircraft, some aircraft are nowadays equipped with a display device configured so as to be secured to the head of the user in the cockpit of an aircraft. Such a device is commonly called an HMD for “head-mounted display.” It is sometimes also called an HWD for “head-worn display.” It generally has a display securely mounted on glasses or a headset, such that the user is able to see information displayed on the display when he wears these glasses or this headset. In the remainder of the description, the term HMD refers equally to an HMD device and an HWD device. HMD devices having a headset are used, for example, in military planes in order to assist in carrying out operations of firing at a target. HMD devices having glasses are used, for example, to implement augmented reality displays. The display is transparent such that the user is able to view the information displayed in augmented reality superimposed on the surroundings. The display of information on the HMD device is controlled depending on the orientation of the user's head. In particular, some information has to be displayed coherently with the external surroundings of the aircraft visible to the user. Thus, in one example shown in FIG. 4a, an aircraft reference symbol 38 (or “aircraft reference”) corresponding to the longitudinal axis 5 of the aircraft, as well as a velocity vector symbol 40 of the aircraft, are displayed in a manner the to be consistent with the surroundings. In the remainder of the description, the term consistent relates to displaying information or a symbol on the transparent display 8, such that this information or this symbol is visible to the user superimposed on the external surroundings of the aircraft, at a position consistent with the meaning of the information or of the symbol. For example, a symbol 36 representing a runway, when it is displayed consistently, is displayed superimposed on the position of the actual runway visible to the user through the windscreen of the aircraft. The display of the symbols 38, 40 and 36, as shown in FIG. 4a, corresponds to a position of the user's head 50 as shown in FIG. 4b, in which the direction 52 of the user's gaze is parallel to the longitudinal axis 5 of the aircraft. As shown in FIG. 4a, the display on the display 8 furthermore comprises a velocity scale 30, an altitude scale 32 and an aircraft roll scale 34. These scales are displayed non-consistently, given that they show information that it is not necessary to display at positions in line with the external surroundings of the aircraft.

When the user turns his head 50, the display of the consistently displayed symbols 38, 40 and 36 is modified so as to remain coherent with the surroundings of the aircraft. The display of the symbols 38, 40 and 36 is thus controlled depending on the orientation of the user's head. This orientation may, for example, be represented by orientation information, corresponding, for example, to at least one angle from among a set of angles as illustrated by FIGS. 3a, 3b and 3c. In these figures, the orientation of the user's head 50 is represented by a straight line 52. In one exemplary embodiment, this straight line 52 corresponds to a theoretical direction of the user's gaze when he is looking to the front without turning his eyes either to the right or to the left and without looking up or looking down. Other definitions of the orientation of the user's head are nevertheless possible. The information about the orientation of the user's head corresponds to at least one angle from among a yaw angle ψ, a pitch angle θ and a roll angle φ, which are illustrated respectively by FIGS. 3a, 3b and 3c. These angles are defined in a reference frame linked to the aircraft. Thus, the yaw angle ψ is an angle defined in projection in a horizontal plane between a straight line 5′ that is parallel to a longitudinal axis 5 of the aircraft and the straight line 52 representing the orientation of the user's head. The pitch angle θ is an angle defined in projection in a vertical plane that is parallel to the longitudinal axis 5 of the aircraft, between a straight line 5″ that is parallel to the longitudinal axis 5 of the aircraft and the straight line 52 representing the orientation of the user's head. As regards the roll angle φ, this is an angle defined in projection in a vertical plane that is perpendicular to the longitudinal axis 5 of the aircraft between a vertical straight line 56 and a yaw axis 54 of the user's head. The information about the orientation of the user's head that is taken into account in order to create the consistent display of the symbols 38, 40 and 36 corresponds to at least one of the angles ψ, θ and φ. As already indicated, when the user turns his head 50, the display of the consistently displayed symbols 38, 40 and 36 is thus modified so as to remain coherent with the surroundings of the aircraft. By contrast, the display of the scales 30, 32 and 34 is not modified on account of the modification of the orientation of the user's head. Thus, for example, when the user turns his head so as to look to the right of the windscreen 4 as illustrated in FIG. 5b (this corresponding to a modification of the yaw angle ψ of the user's head), the display on the display 8 is modified as illustrated in FIG. 5a. With respect to the display shown in FIG. 4a, the consistently displayed symbols 38, 40 and 36 are shifted to the left of the display, whereas the non-consistently displayed scales 30, 32 and 34 remain displayed at the same position. Similarly, when the user turns his head so as to look to the left of the windscreen 4 as illustrated in FIG. 6b (this corresponding to a modification of the yaw angle ψ of the user's head), the display on the display 8 is modified as illustrated in FIG. 6a. With respect to the display shown in FIG. 4a, the consistently displayed symbols 38, 40 and 36 are shifted to the right of the display, whereas the non-consistently displayed scales 30, 32 and 34 remain displayed at the same position.

The display is thus adapted regardless of the movements of the user's head. However, in the event of rapid rotational movements of the user's head, the user may sometimes have a sensation of the non-consistently displayed symbols (the scales 30, 32 and 34 in the above example) scrolling with respect to the external surroundings of the aircraft. This scrolling sensation may sometimes lead to the user having an impression of the gaze being confined between the various scales 30, 32 and 34. This sensation may also lead to a decrease in the user's perception of the reference of the axis of the aircraft (corresponding to the symbol 38) and of the trajectory reference (velocity vector of the aircraft corresponding to the symbol 40). This sensation may also lead to a decreased perception of the angular turning velocity of the aircraft in the case of a rotational movement of the user's head during a turn of the aircraft. It would therefore be desirable to find a solution to reduce this scrolling sensation.

### SUMMARY OF THE INVENTION

The aim of the present invention is in particular to provide a solution to this need. It relates to a display system for a cockpit of an aircraft, comprising:
a display device configured so as to be secured to the head of a user in the cockpit of the aircraft;
a sensor for sensing the position, orientation and/or acceleration of the head of the user of the display device; and
a display computer configured so as to control the display of information relating to the flight of the aircraft on the display device, this information comprising at least one first consistently displayed symbol for assisting the piloting of the aircraft and at least one second non-consistently displayed symbol for assisting the piloting of the aircraft.

This system is noteworthy in that the display computer is configured so as to:
determine at least one angular velocity value of the user's head on the basis of information provided by the sensor;
compare the angular velocity value of the user's head with a predetermined angular velocity threshold; and
control the display on the display device in:
a first display mode for displaying the at least one first piloting assistance symbol and the at least one second piloting assistance symbol when the value of the angular velocity of the user's head is less than or equal to the predetermined angular velocity threshold; and
a second display mode for displaying the at least one first piloting assistance symbol and the at least one second piloting assistance symbol when the value of the angular velocity of the user's head is greater than the predetermined angular velocity threshold, this second mode corresponding to a display in which the visibility of the at least one second piloting assistance symbol to the pilot is less than the visibility of the at least one second piloting assistance symbol in the first display mode.

Thus, when the value of the angular velocity of the user's head is greater than the predetermined angular velocity threshold, that is to say, upon a rapid rotational movement of the user's head, the at least one second symbol is displayed non-consistently with attenuated visibility. Therefore, as this at least one second symbol is less visible to the user upon a rapid rotational movement of his head, the sensation of the at least one second symbol scrolling with respect to the surroundings is attenuated.

According to various embodiments, which may be combined with one another:
the angular velocity of the user's head corresponds to a horizontal angular velocity or to a vertical angular velocity;
in the first display mode, the display computer is configured so as to control the display of the at least one second piloting assistance symbol with a visibility to the pilot similar to the visibility to the pilot of the at least one first piloting assistance symbol;
the display computer is configured so as to control the display of the at least one second piloting assistance symbol with a first brightness level in the first display mode and with a second brightness level in the second display mode, the second brightness level being less than the first brightness level;
the display computer is configured so as to control the display of the at least one second piloting assistance symbol with a first line thickness level in the first display mode and with a second line thickness level in the second display mode, the second line thickness level being less than the first line thickness level.

The invention also relates to a display method in a cockpit of an aircraft, the aircraft having a display system comprising:
a display device configured so as to be secured to the head of a user in the cockpit of the aircraft;
a sensor for sensing the position, orientation and/or acceleration of the head of a user of the display device; and
a display computer configured so as to control the display of information relating to the flight of the aircraft on the display device, this information comprising at least one first consistently displayed symbol for assisting the piloting of the aircraft and at least one second non-consistently displayed symbol for assisting the piloting of the aircraft.

The method is noteworthy in that it comprises the following steps implemented by the display computer:
determining at least one angular velocity value of the user's head on the basis of information provided by the sensor;
comparing the angular velocity value of the user's head with a predetermined angular velocity threshold; and
controlling the display on the display device in:
a first display mode for displaying the at least one first piloting assistance symbol and the at least one second piloting assistance symbol when the value of the angular velocity of the user's head is less than or equal to the predetermined angular velocity threshold; and
a second display mode for displaying the at least one first piloting assistance symbol and the at least one second piloting assistance symbol when the value of the angular velocity of the user's head is greater than the predetermined angular velocity threshold, this second mode corresponding to a display in which the visibility of the at least one second piloting assistance symbol to the pilot is less than the visibility of the at least one second piloting assistance symbol in the first display mode.

According to various embodiments, which may be combined with one another:
in the step of controlling the display on the display device, the display computer controls the display of the at least one second piloting assistance symbol with a visibility to the pilot similar to the visibility to the pilot of the at least one first piloting assistance symbol.
in the step of controlling the display on the display device, the display computer controls the display of the at least one second piloting assistance symbol with a first brightness level in the first display mode and with a second brightness level in the second display mode, the second brightness level being less than the first brightness level.
in the step of controlling the display on the display device, the display computer controls the display of the at least one second piloting assistance symbol with a first line thickness level in the first display mode and with a second line thickness level in the second display mode, the second line thickness level being less than the first line thickness level.

The invention also relates to an aircraft having a display system as mentioned above.

### BRIEF DESCRIPTION OF THE DRAWINGS

The invention will be better understood on reading the following description and on examining the appended figures.

FIG. 1 illustrates, in a simplified manner, an aircraft having a cockpit.

FIG. 2 schematically illustrates a display system in a cockpit of an aircraft according to one embodiment of the invention.

FIG. 3a, already described, illustrates the orientation of the head of a user of the display system, in a plan view.

FIG. 3b, already described, illustrates the orientation of the head of a user of the display system, in a side view.

FIG. 3c, already described, illustrates the orientation of the head of a user of the display system, in a rear view.

FIG. 4a, already described, illustrates an exemplary display on an HMD display device.

FIG. 4b, already described, shows the orientation of the head of a user of the HMD display device, corresponding to the display of FIG. 4a.

FIG. 5a, already described, illustrates an exemplary display on an HMD display device.

FIG. 5b, already described, shows the orientation of the head of a user of the HMD display device, corresponding to the display of FIG. 5a.

FIG. 6a, already described, illustrates an exemplary display on an HMD display device.

FIG. 6b, already described, shows the orientation of the head of a user of the HMD display device, corresponding to the display of FIG. 6a.

FIG. 7a illustrates an exemplary display on an HMD display device, according to one embodiment of the invention.

FIG. 7b illustrates an exemplary display on an HMD display device, according to one embodiment of the invention.

### DETAILED DESCRIPTION OF THE PREFERRED EMBODIMENTS

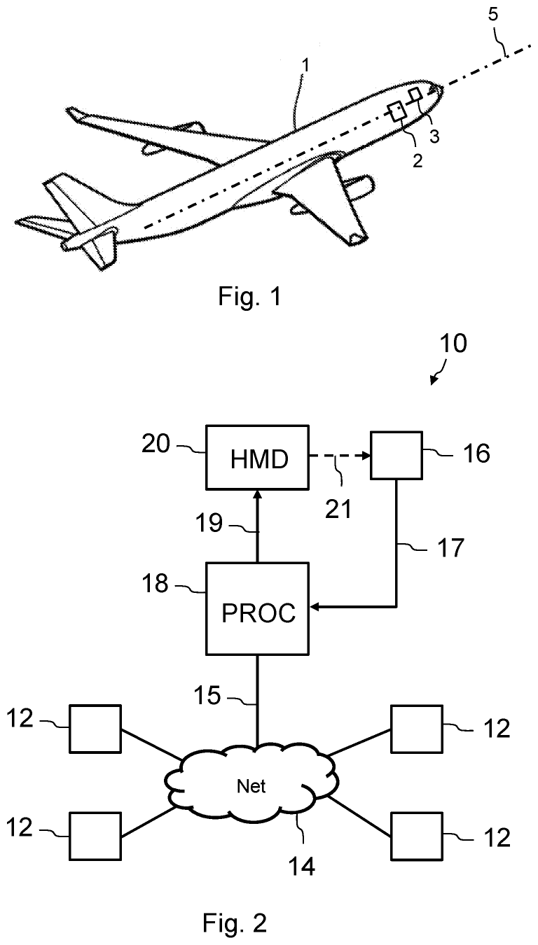

The aircraft 1 shown in FIG. 1 has a cockpit 3 in a front part of the aircraft. It has a longitudinal axis 5, corresponding to a roll axis of the aircraft. This longitudinal axis is substantially horizontal when the aircraft is parked on the ground. The aircraft also has a yaw axis (not shown) that is substantially vertical when the aircraft is parked on the ground. By convention, in the remainder of the description, the term horizontal refers to a straight line or a plane that is substantially horizontal when the aircraft is parked on the ground, such that this straight line or this plane is perpendicular to the yaw axis of the aircraft. Similarly, the term vertical refers to a straight line or a plane that is substantially vertical when the aircraft is parked on the ground, such that this straight line or this plane is parallel to (or contains) the yaw axis of the aircraft.

The display system 10 shown in FIG. 2 has a display computer 18 comprising a processing unit (denoted by PROC in the figure). This processing unit may, in particular, correspond to a processor or a microprocessor of the display computer. According to various embodiments, the display computer 18 is a common display computer controlling a plurality of display devices of the aircraft or else a computer dedicated to the display system 10. In one particular embodiment, this computer corresponds to an IMA (integrated modular avionics) computer that also supports functions other than the display function. The display system 10 furthermore has a display device 20 configured so as to be secured to the head of a user in the cockpit of the aircraft. This display device corresponds to an HMD (or HWD) display device as mentioned above. It is linked to the display computer 18 by a link 19. The display system 10 also has a sensor 16 for sensing the position, orientation or acceleration of the head of a user of the display device, in particular of a pilot of the aircraft. This sensor 16 is linked at output to the display computer 18 by a link 17. In one particular embodiment, the sensor 16 is securely mounted on the display device 20, as shown symbolically by the dashed arrow 21. It then corresponds, for example, to a set of inertial sensors that are integrated into the display device 20. In another particular embodiment, the sensor 16 is securely mounted on the cockpit 3 of the aircraft. It then corresponds, for example, to a camera positioned so as to automatically monitor the head of a user of the display device 20. The display computer 18 is linked to at least one avionics computer 12 of the aircraft. In the particular example shown in FIG. 2, the display computer is linked to a plurality of avionics computers 12 by a link 15 of a communication network 14 (denoted by “Net” in the figure) to which these avionics computers are also linked. The avionics computers 12 are, for example, located in an avionics bay 2 of the aircraft.

During operation, the display computer 18 is configured so as to control the display of information relating to the flight of the aircraft on the display device 20. This information relating to the flight of the aircraft arises from the at least one avionics computer 12 or is determined by the display computer 18 on the basis of information received from the at least one avionics computer 12. As is conventional, this information comprises at least one first consistently displayed symbol for assisting the piloting of the aircraft and at least one second non-consistently displayed symbol for assisting the piloting of the aircraft.

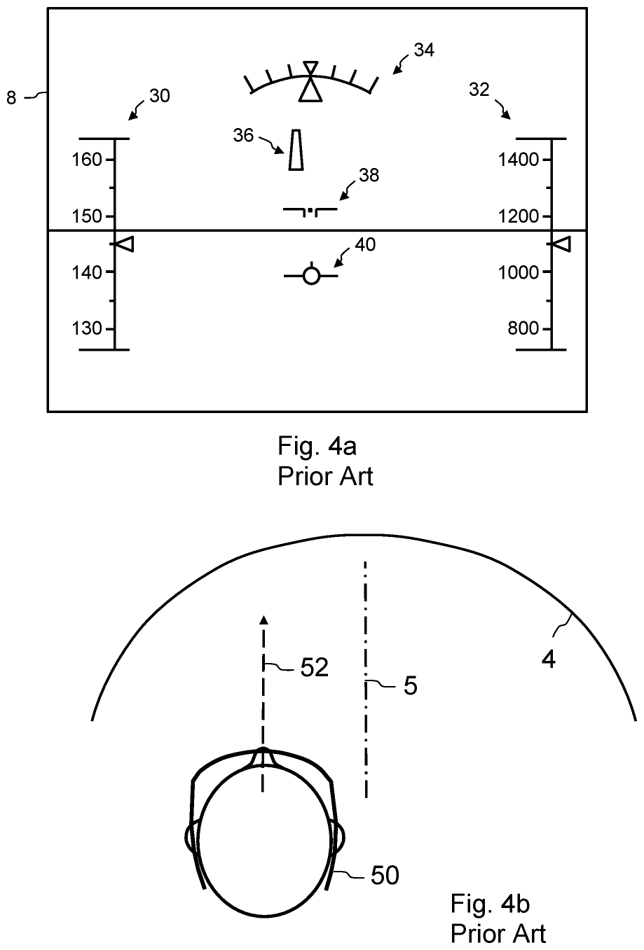

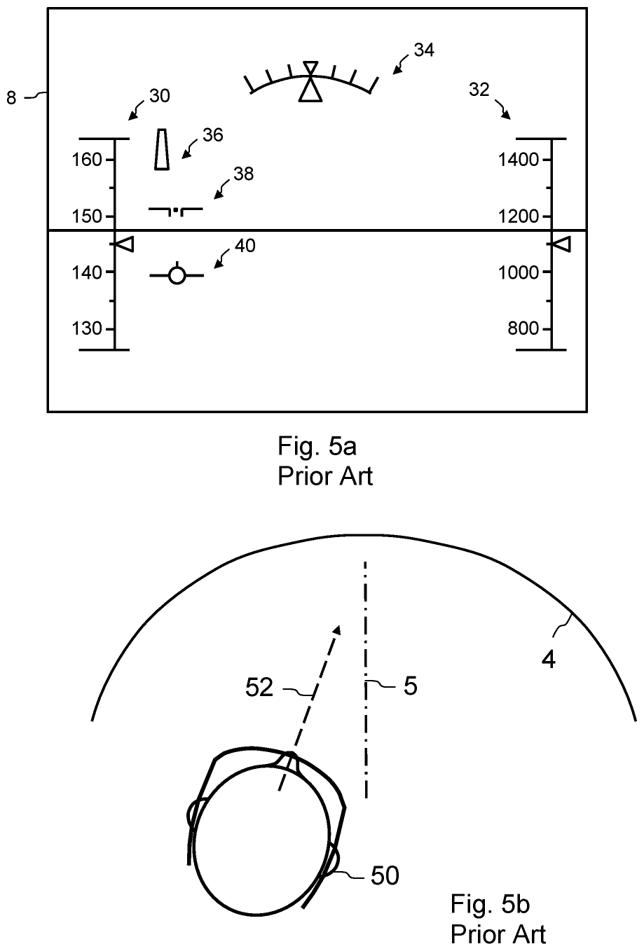

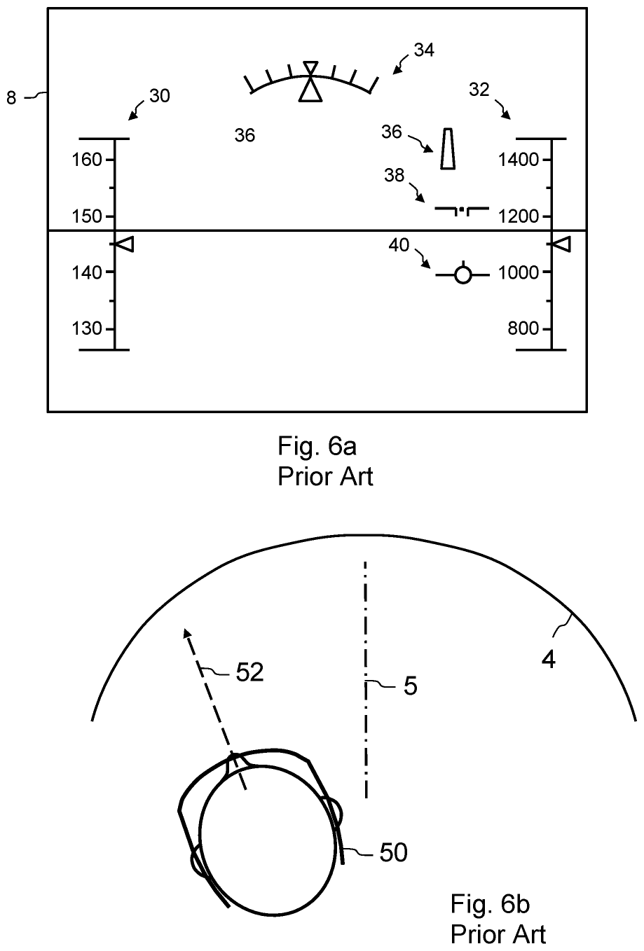

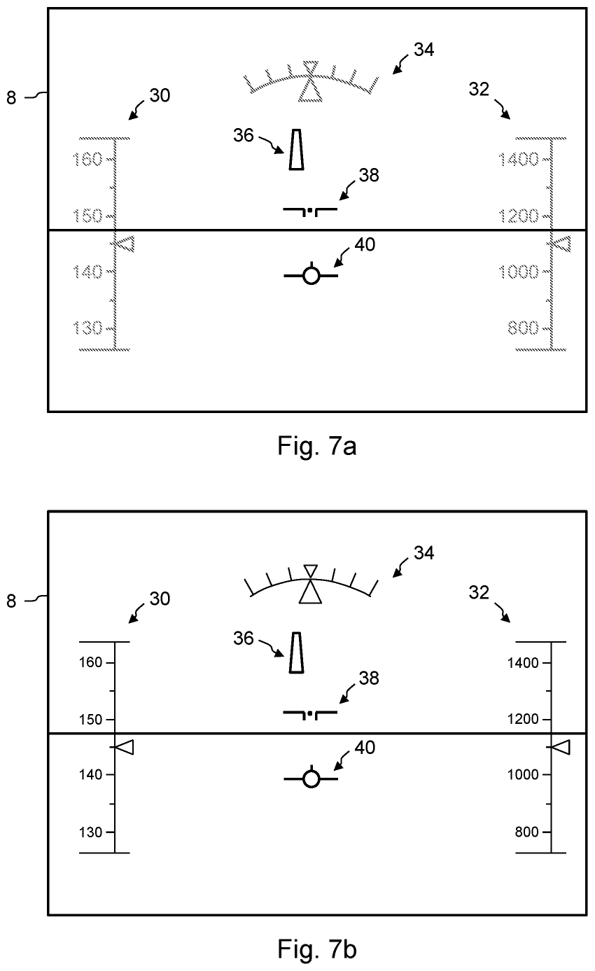

In one example shown in FIG. 7a, the at least one first consistently displayed symbol corresponds to an aircraft reference symbol 38, to a velocity vector symbol 40 of the aircraft, and to a symbol 36 representing a runway. These three symbols 38, 40 and 36 are displayed such that their visibility to the user (in particular, the pilot of the aircraft) is similar to the visibility of the same symbols in a display system from the prior art (for example, a system implementing the displays illustrated in FIGS. 4a, 5a and 6a). In the example shown in FIG. 7a, the at least one second non-consistently displayed symbol corresponds to a velocity scale 30, to an altitude scale 32 and to a roll scale 34 of the aircraft. The display computer 18 controls the visibility to the user of the at least one second symbol, as explained below.

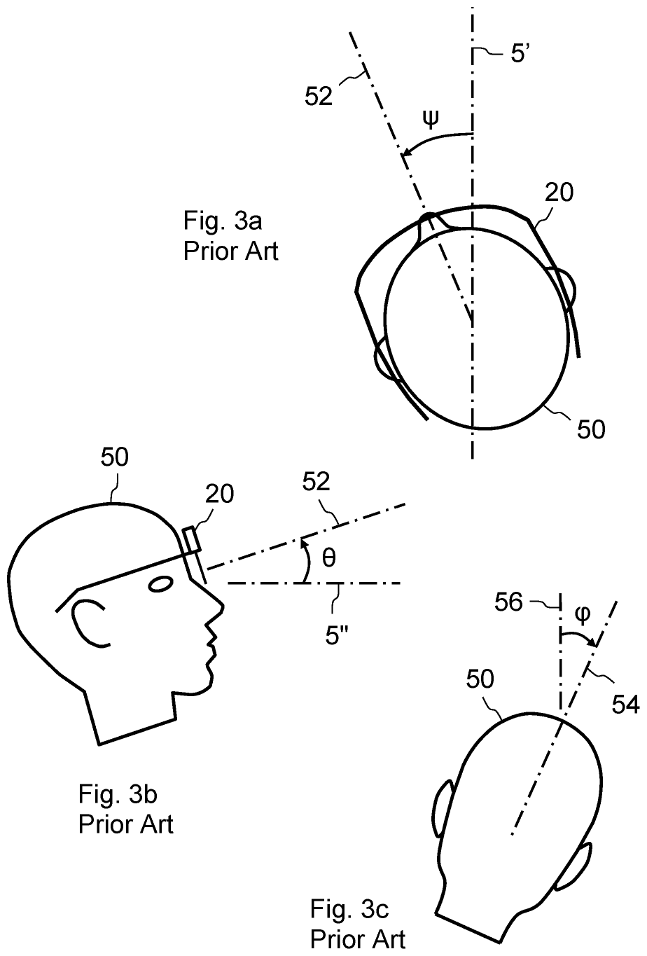

The sensor 16 provides at output, on the link 17, information about the position, orientation or acceleration of the head of the user of the display device 20. This information is received by the display computer 18 that acquires it. On the basis of the information, the display computer 18 determines at least one angular velocity value of the user's head. This at least one angular velocity value corresponds, for example, to a horizontal angular velocity or to a vertical angular velocity. The term horizontal angular velocity refers to an angular velocity relative to a rotation of the user's head about the yaw axis ψ and the term vertical angular velocity refers to an angular velocity relative to a rotation of the user's head about the pitch axis θ, the yaw ψ and pitch θ angles being such as defined above and illustrated respectively by FIGS. 3a and 3b.

The display computer 18 compares the angular velocity value of the user's head with a predetermined angular velocity threshold. The angular velocity is preferably considered in terms of absolute value, such that its value is positive regardless of the direction of rotation of the user's head. When the value of the angular velocity of the user's head is less than or equal to the predetermined angular velocity threshold, the at least one second symbol is displayed non-consistently in a first display mode in which the visibility to the user of the at least one second symbol is for example similar to the visibility to the user of the at least one first consistently displayed symbol. This corresponds to a display of the scales 30, 32 and 34 similar to that shown in FIGS. 4a, 5a and 6a. When the value of the angular velocity of the user's head is greater than the predetermined angular velocity threshold, the at least one second symbol is displayed non-consistently in a second display mode in which the visibility to the user of the at least one second symbol is less than the visibility to the user of the at least one first consistently displayed symbol.

In a first variant illustrated in FIG. 7a, the scales 30, 32 and 34 corresponding to the at least one second symbol are displayed in the second display mode with a second brightness level less than a first brightness level used to display the scales in the first display mode. These scales are thus displayed with a visibility to the user that is lower than in the first display mode.

In a second variant illustrated in FIG. 7b, the scales 30, 32 and 34 corresponding to the at least one second symbol are displayed in the second display mode with a second line thickness level less than a first line thickness level used to display the scales in the first display mode. These scales are thus displayed with a visibility to the user that is lower than in the first display mode.

The display of the scales 30, 32 and 34 corresponding to the at least one second symbol is thus less visible to the user when the angular velocity of the user's head is greater than the predetermined angular velocity threshold than when this angular velocity is less than or equal to this predetermined angular velocity threshold. The predetermined angular velocity threshold is, for example, determined experimentally such that the scrolling sensation (with respect to the external surroundings of the aircraft) of the scales 30, 32 and 34 corresponding to the at least one second non-consistently displayed symbol is attenuated enough to be acceptable to a pilot of the aircraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A display system for a cockpit of an aircraft, comprising:
a display device configured to be secured to a head of a user in the cockpit of the aircraft;
a sensor configured to sense at least one of a position, orientation or acceleration of the head of the user of the display device; and
a display computer configured to control a display of information relating to a flight of the aircraft on the display device, this information comprising at least one first consistently displayed symbol to assist a piloting of the aircraft and at least one second non-consistently displayed symbol to assist the piloting of the aircraft,
wherein the display computer is configured to:
determine at least one angular velocity value of the user's head based on information provided by the sensor;
compare said angular velocity value of the user's head with a predetermined angular velocity threshold; and
control the display on the display device in:
a first display mode for displaying the at least one first piloting assistance symbol and the at least one second piloting assistance symbol when the value of the angular velocity of the user's head is less than or equal to the predetermined angular velocity threshold; and
a second display mode for displaying the at least one first piloting assistance symbol and the at least one second piloting assistance symbol when the value of the angular velocity of the user's head is greater than the predetermined angular velocity threshold, this second mode corresponding to a display in which a visibility of the at least one second piloting assistance symbol to the user is less than a visibility of said at least one second piloting assistance symbol in the first display mode.

2. The system according to claim 1, wherein said angular velocity of the user's head corresponds to a horizontal angular velocity or to a vertical angular velocity.

3. The system according to claim 1, wherein, in the first display mode, the display computer is configured so as to control the display of the at least one second piloting assistance symbol with a visibility to the user similar to the visibility to the user of the at least one first piloting assistance symbol.

4. The system according to claim 1, wherein the display computer is configured to control the display of the at least one second piloting assistance symbol with a first brightness level in the first display mode and with a second brightness level in the second display mode, the second brightness level being less than the first brightness level.

5. The system according to claim 1, wherein the display computer is configured so as to control the display of the at least one second piloting assistance symbol with a first line thickness level in the first display mode and with a second line thickness level in the second display mode, the second line thickness level being less than the first line thickness level.

6. A display method in a cockpit of an aircraft, the aircraft having a display system comprising:
a display device configured so as to be secured to a head of a user in the cockpit of the aircraft;
a sensor for sensing at least one of a position, orientation or acceleration of the head of a user of the display device; and
a display computer configured so as to control a display of information relating to a flight of the aircraft on the display device, this information comprising at least one first consistently displayed symbol for assisting a piloting of the aircraft and at least one second non-consistently displayed symbol for assisting the piloting of the aircraft,
the method comprising the following steps implemented by the display computer:
determining at least one angular velocity value of the user's head based on information provided by the sensor;
comparing said angular velocity value of the user's head with a predetermined angular velocity threshold; and
controlling the display on the display device in:
a first display mode for displaying the at least one first piloting assistance symbol and the at least one second piloting assistance symbol when the value of the angular velocity of the user's head is less than or equal to the predetermined angular velocity threshold; and
a second display mode for displaying the at least one first piloting assistance symbol and the at least one second piloting assistance symbol when the value of the angular velocity of the user's head is greater than the predetermined angular velocity threshold, this second mode corresponding to a display in which a visibility of the at least one second piloting assistance symbol to the user is less than a visibility of said at least one second piloting assistance symbol in the first display mode.

7. The method according to claim 6, wherein, in the step of controlling the display on the display device, the display computer controls the display of the at least one second piloting assistance symbol with a visibility to the user similar to the visibility to the user of the at least one first piloting assistance symbol.

8. The method according to claim 6, wherein, in the step of controlling the display on the display device, the display computer controls the display of the at least one second piloting assistance symbol with a first brightness level in the first display mode and with a second brightness level in the second display mode, the second brightness level being less than the first brightness level.

9. The method according to claim 6, wherein, in the step of controlling the display on the display device, the display computer controls the display of the at least one second piloting assistance symbol with a first line thickness level in the first display mode and with a second line thickness level in the second display mode, the second line thickness level being less than the first line thickness level.

10. An aircraft comprising a display system according to claim 1.
